(19) United States
(12) Patent Application Publication
(10) Pub. No.: US 2024/0371563 A1
(43) Pub. Date: Nov. 7, 2024

(54) INDUCTIVE USER INTERFACE SWITCH

(71) Applicant: AZOTEQ HOLDINGS LIMITED, Nicosia (CY)

(72) Inventors: Frederick Johannes BRUWER, Paarl (ZA); Dieter Sydney-Charles MELLET, Paarl (ZA); Daniël Barend RADEMEYER, Paarl (ZA); Jean VILJOEN, Paarl (ZA)

(21) Appl. No.: 18/654,033

(22) Filed: May 3, 2024

(30) Foreign Application Priority Data
May 5, 2023 (ZA) 2023/04976
Sep. 20, 2023 (ZA) 2023/08882

(51) Int. Cl. H01F 27/24; H01F 17/00; H01H 13/702; H01H 13/85

(52) U.S. Cl. CPC H01F 27/24; H01F 17/0013; H01H 13/702; H01H 13/85

(57) ABSTRACT

A non-electromechanical-contact switch which includes an interfering member which is displaceable into a core of an inductor thereby to change the inductance of the inductor in a manner which is related to the degree of displacement of the interfering member.

### CROSS-REFERENCE TO RELATED APPLICATION

The present application claims priority from South Africa applications ZA 2023/04976, filed May 5, 2023, and ZA 2023/08882, filed Sep. 20, 2023, the contents of which are hereby incorporated by reference into this application.

### BACKGROUND OF THE INVENTION

A keyboard switch of the kind produced by Cherry, Unionwell or Kailh is typically an electromechanical device with two connections which allow for determination of an open or closed switch. This type of switch is binary (1 or 0). Its operation indicates a single point distance of travel of an actuator and depends on physical contact which gives rise to normal wear and tear.

Optical and magnetic switches can measure and report travel distance. However, optical switches are expensive especially to report multiple levels and are susceptible to dust or dirt. Magnetic/Hall effect switches need a magnet and a Hall effect sensor for each key. The sensor and the magnet are costly. The Hall switches are also susceptible to stray magnetic fields.

### SUMMARY OF THE INVENTION

A switch, e.g. a keyboard switch, micro switch or other switch type according to the current invention includes an inductive coil on a suitable carrier e.g. a printed circuit board (PCB) or other material like PET with printed or otherwise formed tracks (hereinafter only referred to as a PCB). The coil is preferably formed by tracks in a circular configuration on a layer below a mechanical part of the switch. A hole goes through the PCB substantially in a centre or core of the coil. The coil is electrically connected to an inductive measurement system. An interfering member penetrates the hole and is moved or displaced from a retracted position into the core of the coil in response to user actuation of the switch. The inductance of the coil is changed in relation to the degree of displacement of the interfering member from the retracted position.

The interfering member is typically biased to the retracted position by means of a spring mechanism or another push back force generating mechanism.

The keyboard switch is used as an example but is not restrictive. A keyboard switch according to this invention is a non-contact device i.e. no electromechanical contact is required for the switch decision. The inductance varies with displacement of the interfering member and hence the speed and depth of actuation can be determined from inductive measurements. Decision levels for the switch (1 or 0) can be set for different positions of the interfering member relative to the coil. Multiple levels can also be determined and used.

The extent (distance) of displacement of the interfering member is related to the change in inductance. Such change in inductance can also be related to the speed of displacement of the interfering member.

The interfering member which occupies space within the core of the coil can be metal e.g. copper, iron etc. that reduces the inductance of the coil or it can be ferrite or a similar material that increases inductance.

Importantly, the magnetic flux inside the core is evenly spread. It is possible to use coil windings on both sides of the PCB with one winding overlying the other. This increases the homogeneous space of magnetic flux that can be affected by the interfering member. In a PCB with more than two layers, adding more layers for the coil can narrow the outside diameter of the coil whilst maintaining a predetermined inductance and thus reduce possible crosstalk/cross coupling between adjacent coils fitted into a predefined area.

The interfering member can be shaped to assist in measuring long key travel and to linearise the relationship between travel and the change in inductance. Linearisation may also be done mathematically. The switch may include a locating guide e.g. of tubular form, which is aligned with the hole in the PCB. The interfering member may be movable back and forth inside the locating guide. The interfering member need not be circular and may be, for example, square or rectangular.

In a different embodiment the alignment and location of a body of the switch and the PCB are achieved through the use of extrusions or pins or other formations that fit into holes in the PCB. In this case where no locating tube is required the interfering member may fill a larger proportion of the hole in the inductor. This results in a greater change in inductance as the interfering member penetrates deeper into the core of the inductor or fills a bigger proportion of the volume of the core.

Some switches include a rod in a central position which guides movement of the switch. The rod is normally made of the same material as a body of the switch. However, a metal or ferrite interfering member may replace the rod or be attached to the rod in a way which affects the inductance of the inductor in response to displacement of the interfering member into the core of the coil, such movement caused by user actuation of the switch.

In some embodiments the conducting rod can be used to sense proximity of a user's finger to a key by operating the said inductive coil (or another electrode) as a capacitive sensor.

The switch structure may be combined with a dome switch plate or structure that may provide a spring action and push back force. Such dome structure may also provide a tactile feedback (snap) when the switch is depressed beyond a certain depth. The dome structure may be metal (e.g. a metal dome plate) or a flexible material such as e.g. rubber or silicone.

It is possible to determine when the dome snaps by analysing the displacement curve as measured with the inductive sensor because at the moment the dome snaps, the back force is reduced and the displacement invariably accelerates. This change in speed of movement is important to align the tactile effect and the switch selection if the switch selection is done using inductive measurements. However, a pre-determined change in inductance may also be selected to make a switching decision; this is assisted by the collapsing effect of the dome structure.

In another embodiment the interfering member may be a magnet and a ferrite layer or ferrite part may cover the inductor (or be positioned inside the inductor core). As the magnet approaches the ferrite/inductor the properties of the ferrite change in a way that affects the measured inductance. From this change in measured inductance the displacement of the interfering member, i.e. the level of depression of the switch by the user, can be derived.

Since the interfering member displacement in the inductor only, and in the magnetic/inductive combination, can be continuously measured, it is possible to provide an analogue equivalent output signal of the switch actuation.

It is also possible to adjust the point of switch activation as this can be determined purely by a software decision. It may, for example, be advantageous to have a very shallow switch activation point i.e. a very light press or a press with short travel, for fast switch operation. On the other hand, a deep switch level may be chosen, for example to inhibit or prevent accidental switch selection. In accordance with this invention the make and break levels of the switch (referred to as switching decisions) can be set at different levels.

Using the selectable level feature, it is possible for a product to offer a context sensitive keyboard response with or without user intervention. For example, a program for gaming may automatically select a shallow trigger level when a shooter operates a pistol, but select a deep trigger level for a rocket propelled grenade or pulling the pin on a hand grenade. This is purely exemplary.

A word processing program may automatically adjust the key selection level according to some metric that determines the user's accuracy or proficiency. Different keys may have different selection levels based on layout and/or another metric, for example hand/finger reach.

In another embodiment the key operation may be adjusted to move the zero or resting level artificially. For example, when a key is pressed repeatedly the user may not fully release the key before depressing it again. It is possible for the keyboard (or program) controller to detect this and, if the key is not fully released, to require only a similar level or a pre-determined level of depression but from the new zero or base level i.e. the key will not be required to be fully released before it can be pressed again and the required displacement level for switch activation is constant. This can be repeated until the key reaches its full operational depth. This method of operation can for example result in much faster switch operation for example for shooting in a game.

In another embodiment users may set up their own preferences for different actions or parts of a program(s) or game.

If a switch is touched resulting in a slight depression and before the selection level of depression is reached (almost similar to a capacitive touch detection) the program may indicate this to a user via visual (or other) feedback. This function can be especially helpful in the dark on a keyboard without backlighting.

Other mechanical switch construction methods are also possible, for example, scissor or butterfly wing implementations that in accordance with this invention move an interfering member into (or out of) the core of an inductive coil to affect the inductance of said coil. Such other switch constructions may for example assist or be targeted to implement low profile or low travel keys such as are used in for example laptops and notebook.

A further application of this invention can be for use in a keyboard switch that makes use of a flexible (e.g. metal, rubber or silicone) dome to provide or generate the push back force against a user activation force and also can provide a snap tactile feel when the dome is pressed beyond a predetermined point and it then collapses (similar to a mechanical dome plate switch effect). These domes are well known in the art. The non-metal dome in some state of the art cases has a conductive (e.g. graphite) layer inside on the top part and when the dome collapses it causes an electrical connection on the PCB or other surface it is mounted on. In another state of the art implementation the dome collapses under user pressure and pressure is then exerted on layers below the dome to form an electrical connection. Both state of the art cases are examples of electromechanical switch construction. In accordance with this invention, it is proposed to have a metal or ferrite part as an interfering member in a top part of the rubber (or applicable material) dome. The interfering member affects the inductance of a coil that is positioned below it when it collapses under user pressure. The interfering member may be embedded in the dome material and no electrical contact is then required. This is beneficial when considering wear and tear which can result from high numbers of actuations.

The interfering member is ideally shaped to move into the core of an inductor when the dome collapses and in this way affects the inductance of an inductor positioned adjacent the dome. The interfering member need not be in the centre of the mechanical switch construction; it only needs to move in relation to the switch activation depression.

Not only can the deforming of the switch be measured but speed of user actuation and depth of switch actuation information can be extracted from the inductive measurements. Repetitive switch activations can also be much faster than for electromechanical switches due to debounce requirements in the latter.

### BRIEF DESCRIPTION OF THE DRAWINGS

The invention is further described by way of examples with reference to the accompanying drawings in which:

FIG. 1a and FIG. 1b illustrate a keyboard switch with an interfering member inside a locating guide in a retracted position and in an activated state respectively,

FIG. 2 is a sectional view of a keyboard switch with an off-centre locating pin and with a centrally positioned interfering member,

FIG. 3 is a sectional view of a keyboard switch in an activated state with an interfering member displaced to a maximum extent through a hole in the PCB,

FIG. 4 is a view from below of the keyboard switch showing the PCB, the inductive coil and locating pins positioned inside locating holes in the PCB,

FIG. 5 shows an inductive sensing keyboard,

FIG. 6 shows a low profile type key constructed to operate in accordance with this invention,

FIGS. 7a, 7b show a dome structure with a flat interfering member,

FIG. 8 shows a dome with a shaped interfering member,

FIG. 9 shows a dome structure with extra pressure sensing features, and

FIG. 10 shows a ferrite layer between a magnetic interfering member and a coil.

### DETAILED DESCRIPTION OF THE INVENTION

The following description is to provide an understanding of the invention with reference to the accompanying drawings. The description is exemplary only and not exhaustive as other implementations of the invention exist which fall inside the scope of the claims.

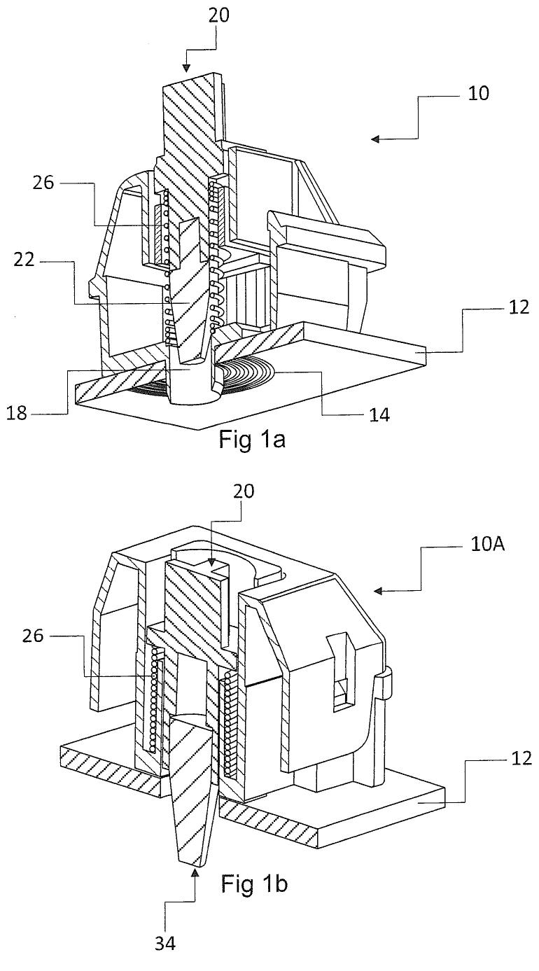

FIGS. 1a and 1b show a keyboard switch 10 mounted to a printed circuit board (PCB) 12. An inductor coil 14 is formed by circular tracks on the PCB. A hole 16 in the centre of the coil penetrates the PCB. A locating guide tube 18 is aligned with and positioned within the hole 16.

A part of the switch 10 which is movable in response to user actuation 20 includes an interfering member 22 which moves, within the guide tube 18, closer and into the inductor coil 14. This change in position causes a change in inductance of the coil 14 that can be measured with a connected inductive measuring integrated circuit (not shown). The coil can be formed on the lower side of the PCB or on the upper side or on both sides. The measurement of inductance, and of a change in inductance, is readily effected using known techniques not described herein.

Displacement of the interfering member 22 is against the push back force of a spring 26 which restores the interfering member to a retracted position in the absence of user actuation force.

A leading end 34 of the interfering member 22 can be flat-nosed to give a more abrupt change in inductance from a first value when the interfering member is just outside the core of the coil, to a second value with the interfering member inside the core of the inductive coil, or the interfering member can be shaped with a varying cross section, from a sharp leading end 34 over a specific length going wider in diameter e.g. with a tapered shape, to allow a variable change in inductance during travel of the interfering member over that length. This shape allows for a gradual change in inductance over the desired distance i.e. from minimum interference to maximum interference.)

It is also possible for the interfering member to have a shape which linearises the relationship between the change in inductance and the actuated displacement.

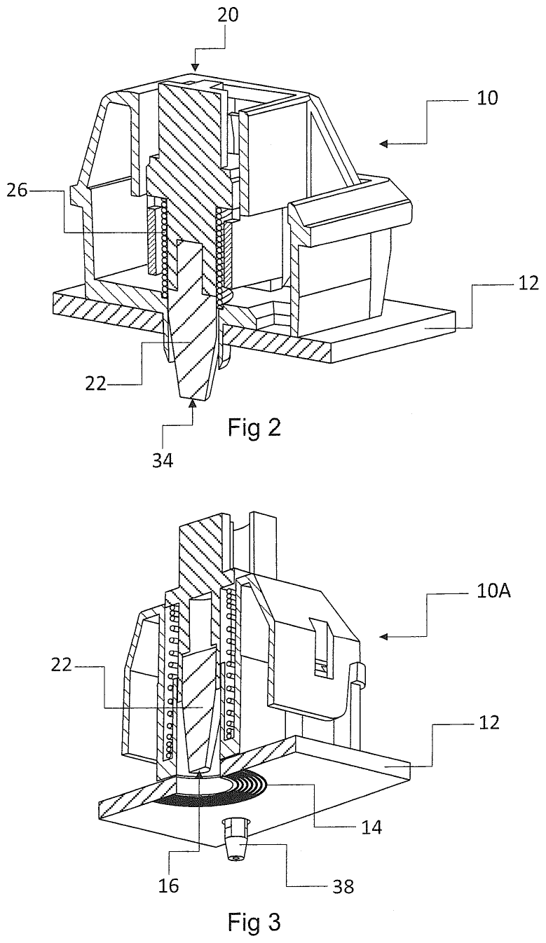

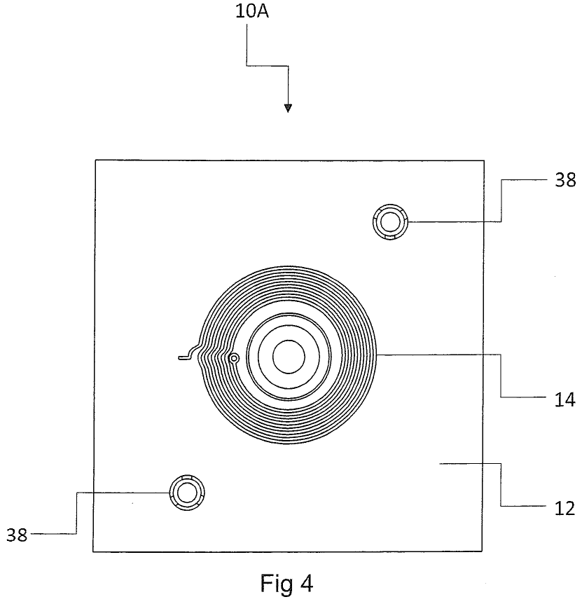

FIGS. 2 and 3 show a keyboard switch 10A, in retracted and activated states, which makes use of off-centre locating pins 38 to position the switch on the PCB 12. FIG. 4 is a plan view from below of the switch 10A. The interfering member can have a larger diameter than in the case where the locating tube guide 18 is used (FIG. 1).

The interfering member, in any embodiment, can be attached to the actuator by means of an adhesive, by means of a mechanical fastening arrangement or in any other practical way.

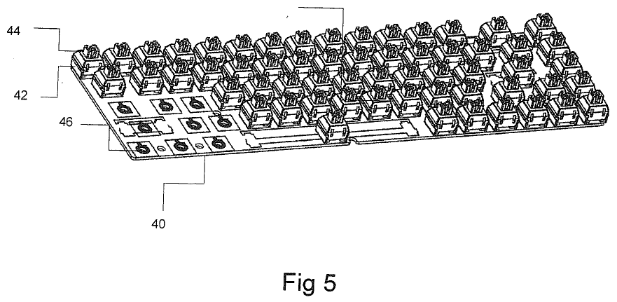

FIG. 5 is a perspective view of a keyboard 40 comprising many switches 44, a switch housing 42, inductive coils 46 under each switch to enable actuation of each switch to be determined by means of a measurement of the inductance of a coil or a change thereof, and electronics (not shown) for measurements and for communication with a computer system. The keyboard may be a stand-alone external unit or may be a part of a computer, for example in a laptop or notebook.

A communications processor on the keyboard may also control switch level selections from user preferences settings or implement dynamic switch level selections as per the descriptions above. The level selection may also be controlled from a program (e.g. a game) running on the computer.

The level settings may be selected per user or may even be determined per session.

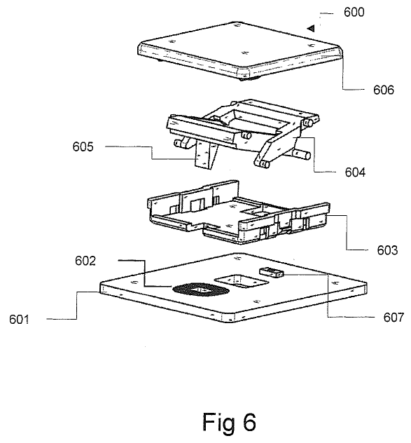

FIG. 6 is an example of a low profile switch 600 (laptop keyboard) adapted to operate as an inductive switch in accordance with this invention. A PCB 601 upon which the switch is mounted may also comprise an inductive coil 602. The switch is constructed with a housing 603, a mechanism 604 and a cover 606. The mechanism 604 has attached to it a member 605 that can be a conductive or ferrite material. When the switch is actuated by a user, the member 605 moves into the core of the coil 602 and in this way affects the measured inductance of the coil 602 in relation to the depth of key depression by the user.

An LED 607 may be used to provide visual indications to the user. To facilitate visual indications, the cover 606 must be transparent or at least have a transparent portion. An integrated circuit for measuring the inductance of the coil 602 is not shown but may be mounted on the PCB 601, and said integrated circuit may handle multiple keys.

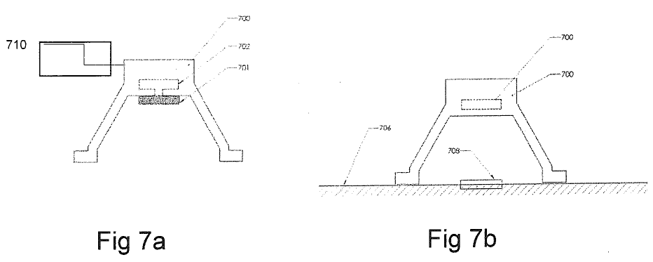

In FIG. 7a an example of a flexible (e.g. silicone) dome 700 type structure 710 with an interfering member 701 is shown. This is a side view of a plane cut through the middle of an exemplary form factor dome. The dome structure is typically spherical from the top. This flexible dome can be seen as replacing a metal (or other) spring mechanism to generate a push back force against a user actuation force, and as such it is used as a part of a mechanical key structure.

The dome 700 is made from a flexible material. The interfering member 701 may be attached to the bottom of the inside top part of the dome. The interfering member 701 may also be moulded into the material for durability—as indicated by the reference 702. As was described earlier an interfering member made of ferrite or another high permeability material will increase the inductance when closer to the inductor, whilst an interfering member comprising an electrically conductive material will, depending on orientation, decrease the inductance as it come closer.

In FIG. 7b the interfering member 704 is completely embedded into the material of the dome 700 and emphases the point that no electrical connection is required. As the dome is pressed by the user to overcome the push back force generated by the dome, the dome sides collapse and the interfering member moves closer to a surface 706 upon which the dome structure is mounted. The interfering member then affects the inductance of an inductor 708 placed underneath the dome.

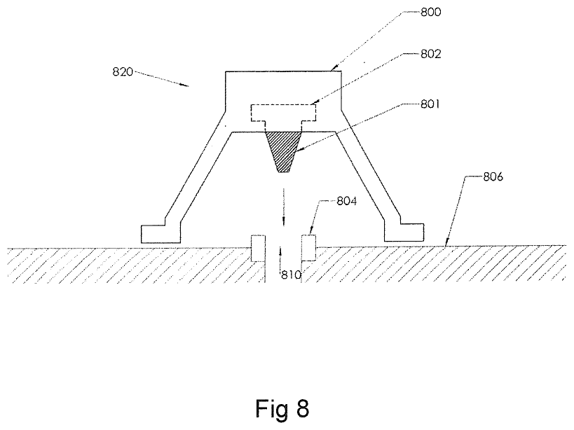

In FIG. 8 an embodiment 820 with a shaped interfering member 801 that will move into the core of an inductor underneath a dome 800, when the dome is depressed, is shown. The inductor may be a coil 804 on a pcb 806 with a hole 810 in the middle into which the interfering member 801 can fit. The inductance is affected by the movement of the interfering member into the core of the coil and the change in inductance can be measured. This is similar to the interfering member and coil arrangement shown in FIG. 1. A part 802 of the member 801 may be embedded in the dome material.

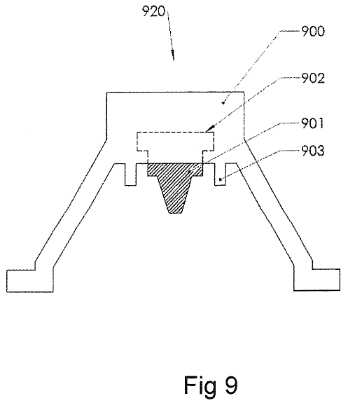

In FIG. 9 an embodiment 920 to allow for the detection of a hard press passed the collapse of a dome 900 is shown. Flexible blocking structures 903 prevent the interfering member 901 from fully entering the core of the inductor (i.e. in a construction similar to that shown in FIG. 8). When sufficient pressure to deform the blocking members 903 is exerted the interfering member 901 will move even closer to the inductor and will cause further changes in the measured inductance.

The flexible domes may be in many shapes, sizes or forms and can be used with many different types of mechanical switch constructions such as scissor or butterfly mechanisms. But in accordance with this invention the actuation is measured without requiring Hall switches or electrical contact.

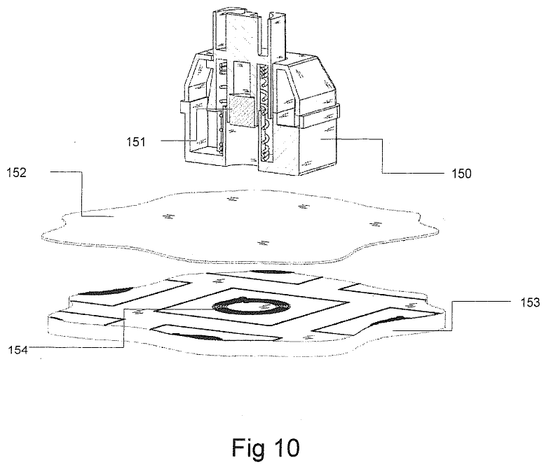

In FIG. 10 a switch embodiment 150 is shown using a magnet 151 as an interfering member and wherein a ferrite material layer 152 is positioned between the interfering member 151 and a coil 154, or in a core of a coil formed on a printed circuit board 153. When the switch 150 is actuated the magnet 151 moves closer to the ferrite material 152 and affects the properties of the ferrite material in a way that affects the inductance of the coil 154. This implementation does not require a magnetic sensor (typically Hall) at each switch. The layer 152 or another layer e.g. of a plastics material (provided for the purpose) acts as a sealing off layer and prevents fluids which may accidentally be spilt on the switch 150 from reaching and then possibly damaging electronics, which may be related to the switch or not, and which are below the layer.

1. A method of implementing a mechanical switch construction, that does not require electromechanical contact for making a switching decision, that includes the step of using an inductance affecting interfering member that is displaced, under user actuation pressure, from a retracted position at one end of a core of an inductor, into the core of said inductor, to change the inductance of said inductor in a way that is related to the displacement of said interfering member.

2. The method in accordance with claim 1 wherein said inductor comprises an inductor coil which is formed by tracks on a suitable carrier which is adjacent the mechanical switch construction and which includes a hole adjacent the core of the inductor coil and wherein the interfering member is displaced into the hole to change the inductance of said inductor.

3. The method in accordance with claim 1 including the step of forming the interfering member with a taper in order to affect the travel distance of the switch that will cause a change in the inductance of the inductor.

4. The method in accordance with claim 2 including the steps of using a flexible dome structure comprising the interfering member, to generate a push back force that works against user pressure that is applied during user actuation of the switch and of using the dome structure to create a tactile feel user sensation as the dome structure collapses when pressure beyond a predetermined level is applied by the user to the top of the dome structure.

5. The method in accordance with claim 4 including the step of using a high permeability material that is non-electrically conducting to increase said change of inductance when the interfering member enters the core of the inductor.

6. The method in accordance with claim 1 including the steps of measuring the change in inductance caused by said displacement of the interfering member and using the measurement information to adjust the distance of displacement of the interfering member that is required for making said switching decision, or to determine the extent of displacement of the interfering member; or the speed of displacement of the interfering member.

7. The method in accordance with claim 1 wherein said mechanical switch construction is implemented in a computer keyboard and wherein the method includes the step of automatically adjusting activation parameters relating to the mechanical switch by means of a program or application running on the computer.

8. The method in accordance with claim 1 including the step of determining a user touch applied to said interfering member from a measurement of the change in such inductance and reporting such touch to apparatus connected to said switch and/or to the user.

9. The method in accordance with claim 1 including the step of locating a sealing off layer below the mechanical switch construction to prevent fluids from coming into contact with electronics below the mechanical switch construction.

10. The method in accordance with claim 2 wherein the interfering member is magnetic, the method including the step of positioning a ferrite layer adjacent to the inductor or in the core of the inductor coil, so that displacement of the magnetic interfering member closer to the ferrite layer affects the inductance of the inductor.

11. A mechanical switch construction mechanism comprising a switch activation which is not dependent on electromechanical contact, further comprising an inductance affecting interfering member, an inductor with a core, and a push back force generating mechanism, wherein the said interfering member is displaceable under a user actuation force against a push back force generated by said push back force generating mechanism, from a retracted position, through a distance to be closer to said inductor core and thereby to change the inductance of the inductor in a way which is related to said distance of displacement of the interfering member.

12. The switch mechanism according to claim 11 wherein the inductor comprises an inductor coil on a carrier, with a hole in the carrier adjacent the core of the inductor coil, and wherein the interfering member is displaceable, under said user actuation force, from the retracted position, which is outside or at one end of the hole, into the hole and into the core of the inductor coil, to change the inductance of said inductor coil, and wherein the inductor coil is formed by tracks on the carrier which optionally is a printed circuit board.

13. The switch mechanism of claim 11 wherein the interfering member has a leading end and has a cross sectional area which increases over a predetermined length from the leading end.

14. The switch mechanism according to claim 11 wherein the push back force generating mechanism comprises a flexible non-electrically conductive dome structure that generates a tactile feel when the said dome structure collapses under said user actuation force, and wherein the dome structure includes said interfering member that is displaceable into the core of the said inductor when the dome structure is depressed.

15. The switch mechanism according to claim 11 which comprises a keyboard switch and which includes an inductive measurement circuit to measure the change in inductance caused by said displacement of the interfering member and wherein information of said measurement is used for at least one of the following: to determine the distance of movement, of a key which is used to displace the interfering member; and the speed of movement, of a key which is used to displace the interfering member.

16. The switch mechanism according to claim 11 which comprises a computer keyboard switch and wherein activation parameters of the switch mechanism are set automatically by a program running on the computer.

17. The switch mechanism according to claim 11 which comprises a keyboard switch and wherein a switching decision is dynamically changed in response to the speed of activation, or the distance of retraction, of a key which is used to displace the interfering member.

18. The switch mechanism according to claim 11 which is configured so that a user touch which causes displacement of the interfering member is detectable and is reported to the user.

19. The switch mechanism according to claim 11 which includes a sealing off layer which is positioned below the switch mechanism in order to prevent fluids from contacting electronics below the sealing off layer.

20. The switch mechanism according to claim 11 wherein the interfering member is magnetic, and which includes a ferrite layer positioned between the interfering member and the inductor so that displacement of the magnetic interfering member closer to the ferrite layer affects the inductance of the inductor.
